(19) United States
(12) Patent Application Publication
(10) Pub. No.: US 2017/0147798 A1
(43) Pub. Date: May 25, 2017

(54) Mobile Device And Method Of Operating Mobile Device

(71) Applicant: SOONGSIL UNIVERSITY RESEARCH CONSORTIUM TECHNO-PARK, Seoul (KR)

(72) Inventors: Jeong-Hyun Yi, Seongnam-si (KR); Yong-Jin Park, Seoul (KR)

(73) Assignee: Soongsil University Research Consortium Techno-Park, Seoul (KR)

(21) Appl. No.: 15/105,302

(22) PCT Filed: Mar. 6, 2015
(86) PCT No.: PCT/KR2015/002207

§ 371 Date: Jun. 16, 2016

(30) Foreign Application Priority Data
Oct. 23, 2014 (KR) 10-2014-0144320
Jan. 8, 2015 (KR) 10-2015-0002944

(51) Int. Cl. G06F 21/14

(52) U.S. Cl. CPC G06F 21/14

(57) ABSTRACT

A mobile device and a method of operating a mobile device are disclosed. The mobile device includes a main processor executing a normal code of a mobile application program, a co-processor executing a core code of the mobile application program, and a co-processor driver enabling the main processor and the co-processor to communicate with each other. The normal code includes commands executable by the main processor, and the core code includes commands executable by the co-processor. Since the core code is separated from the mobile application program on a level lower than an operating system level when the mobile application program is installed on the mobile device and the core code is stored in a core code storage to which the main processor is not allowed to access directly, the core code is not exposed to an attacker, such that resistance to a reverse engineering attack is increased.

### THE ART TO WHICH THE INVENTIVE CONCEPT

Example embodiments generally relate to a mobile device and a method of operating the mobile device, and more particularly relate to a mobile device that is able to protect a core code of a mobile application program and a method of operating the mobile device.

### BACKGROUND OF THE INVENTIVE CONCEPT

Although many people use a smart phone banking, a security of the smart phone banking is not strong. The smart phone is vulnerable to an attack since the smart phone is connected to an internet, which is a public network. Information stored in the smart phone may be leaked through the internet by a hacker, and the smart phone may be exposed to an attack by a malicious code or a phishing. In addition, financial information of a user may be leaked by a tampered banking application.

Game applications and SNS (Social Network Service) applications are also vulnerable to an attack as well as financial applications supporting a smart phone banking.

Actually, personal information is leaked by the Trojan horse virus inserted in a tampered application of a game application, and a tampered application of an SNS application illegally charges to a user.

Researches have been developed to prevent an application tampering and to secure an integrity of an application. Most of the researches are related to technologies for decreasing a possibility of a reverse engineering and an application tampering using a code obfuscation and an anti-debugging.

However, conventional tamper detection technologies using a tamper detection code on an application level is vulnerable to an attack since an attacker can analyze a structure of the application using the tamper detection code. For example, if an attacker extracts a Dalvik bytecode executed on a Dalvik virtual machine of an Android mobile system, the attacker can analyze a structure of an application. That is, tamper detection technologies of an application level may be evaded by an attacker. Therefore, tamper detection technologies of an platform level are required.

Conventional technologies protect a core code of a mobile application program by performing a code obfuscation on the core code, and the code obfuscation is performed by storing a file separated from the mobile application program in a remote server on an internet.

However, a connection to a remote server is not guaranteed on a mobile environment due to an unstable situation of an internet, such that the application may not be executed.

In addition, if data consumption is too excessive, it is difficult to apply the conventional technologies in the real field.

The background art of the present invention has been described in Korean Patent Registration No. 10-1328012 (2013 Nov. 13).

### CONTENT OF THE INVENTIVE CONCEPT

### Technical Object of the Inventive Concept

Some example embodiments of the inventive concept provide a mobile device that is able to protect a core code of a mobile application program by separating the core code in a form executable by a co-processor, which is different from a main processor, and a method of operating the mobile device.

### Means for Achieving the Technical Object

According to example embodiments, a mobile device includes a main processor executing a normal code of a mobile application program, a co-processor executing a core code of the mobile application program, and a co-processor driver coupled between the main processor and the co-processor. The co-processor driver enables the main processor and the co-processor to communicate with each other. The normal code includes commands executable by the main processor, and the core code includes commands executable by the co-processor.

In a method of operating a mobile device including a main processor, a co-processor, and a co-processor driver enabling the main processor and the co-processor to communicate with each other, the main processor calls a core code of a mobile application program. The core code includes commands executable by the co-processor. The co-processor driver transfers the core code call received from the main processor to the co-processor. The co-processor transfers a core code execution result to the co-processor driver after executing the core code. The co-processor driver transfers the core code execution result to the main processor.

### Effects of the Inventive Concept

Since a core code of a mobile application program is separated from the mobile application program on a level lower than an operating system level when the mobile application program is installed on a mobile device and the core code is stored in a core code storage to which a main processor and a normal code of the mobile application program are not allowed to access directly, the core code is not exposed to an attacker. Therefore, the mobile application program has an increased resistance to a reverse engineering attack.

In addition, since the core code is executed by a co-processor of the mobile device, the core code is not exposed to the main processor of the mobile device. Therefore, a dynamic analysis of the mobile application program using the main processor is prevented, such that the mobile application program has an increased resistance to a reverse engineering attack.

In addition, since the present invention uses the co-processor instead of using a network, the mobile device according to example embodiments operates stably in a mobile environment. Further, since the core code is developed adaptive to the co-processor of the mobile device, a command group of the separated core code or a structure of the separated core code is changed. Therefore, the mobile application program has an increased resistance to a reverse engineering attack.

In addition, since the main processor and the co-processor of the mobile device shares an encrypted shared memory at a time when the mobile application program is executed, the mobile application program has an increased resistance to a reverse engineering attack.

In addition, since the core code is not distributed separately but the mobile application program including the core code is distributed like a conventional distribution process, a user do not notice a difference although the core code is separated and stored separately. Therefore, the present invention does not occur a reluctance to the user.

### BRIEF DESCRIPTION OF THE DRAWINGS

FIG. 1 is a diagram illustrating a code division of a mobile application program according to example embodiments.

FIG. 2 is a block diagram illustrating a mobile device according to example embodiments.

FIG. 3 is a block diagram illustrating an example of a main processor included in the mobile device of FIG. 2.

FIG. 4 is a block diagram illustrating an example of a co-processor included in the mobile device of FIG. 2.

FIG. 5 is a flow chart illustrating an operation of a mobile device according to example embodiments.

### PARTICULAR CONTENTS FOR IMPLEMENTING THE INVENTIVE CONCEPT

Various example embodiments will be described more fully with reference to the accompanying drawings, in which some example embodiments are shown. The present inventive concept may, however, be embodied in many different forms and should not be construed as limited to the embodiments set forth herein. Rather, these embodiments are provided so that this disclosure will be thorough and complete, and will fully convey the scope of the present inventive concept to those skilled in the art. Like reference numerals refer to like elements throughout this application.

It will be understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be further understood that the term “circuit”, when used herein, specifies a unit performing at least one function or an operation, which is implemented with a hardware, a software, or a combination of a hardware and a software.

Hereinafter, various example embodiments will be described fully with reference to the accompanying drawings.

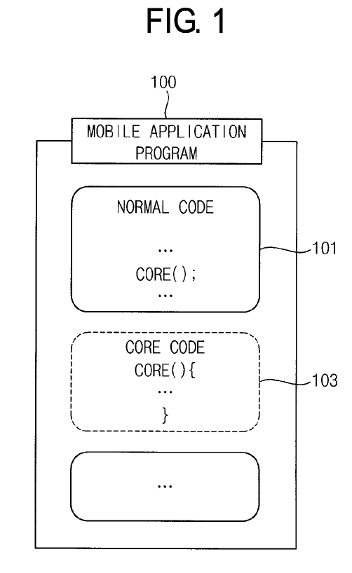

FIG. 1 is a diagram illustrating a code division of a mobile application program according to example embodiments.

Referring to FIG. 1, a mobile application program 100 represents an application which is installed and executed on a mobile device. For example, the mobile application program 100 may include an App executable on a smart phone. A user may download the App from a mobile application market, which corresponds to a virtual market for trading mobile contents, to install the App on a mobile device such as a smart phone.

Here, the mobile device may include any terminals on which the mobile application program 100 is installed and executed, such as a smart phone, a smart pad, a cellular phone, a laptop computer, a tablet computer, a personal digital assistant (PDA), etc. In case of the smart phone and the smart pad, the mobile application program 100 may be provided as an application.

The mobile application program 100 may include a core code file and a normal code file. The core code file may include a core code 103 which is required to be protected from a tampering attack, and the normal code file may include a normal code 101 which corresponds to the rest of the mobile application program 100 except for the core code 103.

In some example embodiments, the core code 103 may be determined by a function predetermined based on a mobile platform. In other example embodiments, the core code 103 may be determined directly by a user, a developer of the mobile application program 100, or a person in charge of a certification of the mobile application program 100.

The core code 103 may correspond to a code which must be executed at least one time while executing the mobile application program 100. For example, the core code 103 may include a part of the mobile application program 100, the execution order of which is not changed based on a condition of a condition statement.

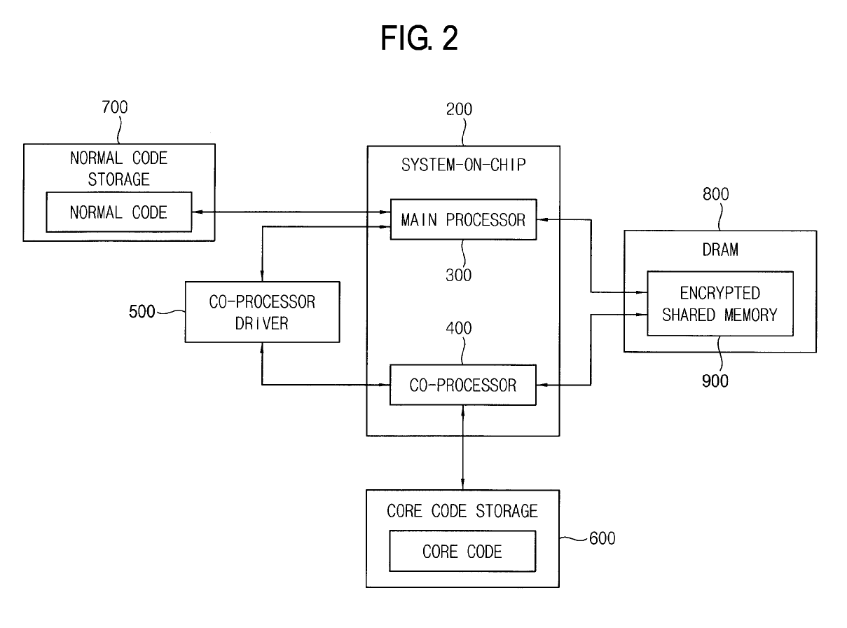

As will be described below with reference to FIGS. 2 to 5, the mobile device may protect the core code 103 of the mobile application program 100 by applying a code obfuscation technology on both a main processor and a co-processor of the mobile device. Therefore, the mobile application program 100 may have an increased resistance to a reverse engineering attack.

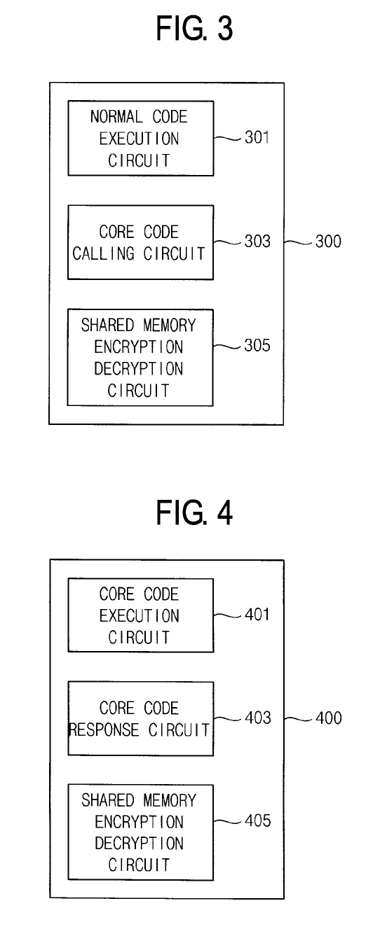

FIG. 2 is a block diagram illustrating a mobile device according to example embodiments, FIG. 3 is a block diagram illustrating an example of a main processor included in the mobile device of FIG. 2, and FIG. 4 is a block diagram illustrating an example of a co-processor included in the mobile device of FIG. 2.

Referring to FIG. 2, the mobile device may include a system-on-chip 200, a main processor 300, a co-processor 400, a co-processor driver 500, a core code storage 600, a normal code storage 700, a dynamic random access memory (DRAM) 800, and an encrypted shared memory 900.

The system-on-chip 200 may include the main processor 300 and the co-processor 400. The main processor 300 may perform a data processing operation in response to a command of the mobile application program 100. The main processor 300 may execute the normal code 101 of the mobile application program 100. The normal code 101 may include commands executable by the main processor 300.

Referring to FIG. 3, the main processor 300 may include a normal code execution circuit 301, a core code calling circuit 303, and a shared memory encryption decryption circuit 305.

The normal code execution circuit 301 may execute the normal code 101 of the mobile application program 100.

While the normal code execution circuit 301 executes the normal code 101 of the mobile application program 100, the core code calling circuit 303 may call the core code 103 of the mobile application program 100 by transferring a core code call to the co-processor driver 500. In addition, the core code calling circuit 303 may receive a core code execution result, which is generated by the co-processor 400, from the co-processor driver 500.

The shared memory encryption decryption circuit 305 may store an execution code, which is executed by the normal code execution circuit 301, in the encrypted shared memory 900 in an encrypted form. In addition, the shared memory encryption decryption circuit 305 may decrypt an encrypted execution code of the co-processor 400, which is stored in the encrypted shared memory 900 by the co-processor 400, to refer the decrypted execution code.

Referring again to FIG. 2, the co-processor 400 may communicate with the main processor 300 through the co-processor driver 500. The co-processor 400 may perform an operation in response to a call from the main processor 300.

The co-processor 400 may execute the core code 103 of the mobile application program 100. The core code 103 may include commands executable by the co-processor 400.

Referring to FIG. 4, the co-processor 400 may include a core code execution circuit 401, a core code response circuit 403, and a shared memory encryption decryption circuit 405.

The core code execution circuit 401 may load the core code 103 of the mobile application program 100 from the core code storage 600 and execute the core code 103.

The core code response circuit 403 may receive the core code call, which is generated by the main processor 300, from the co-processor driver 500. In addition, the core code response circuit 403 may transfer the core code execution result, which is generated by the core code execution circuit 401, to the co-processor driver 500.

The shared memory encryption decryption circuit 405 may decrypt the encrypted execution code of the main processor 300, which is stored in the encrypted shared memory 900 by the main processor 300, to refer the decrypted execution code. In addition, while the core code execution circuit 401 executes the core code 103 of the mobile application program 100, the shared memory encryption decryption circuit 405 may store an execution code, which is executed by the core code execution circuit 401, in the encrypted shared memory 900 in an encrypted form.

Referring again to FIG. 2, the co-processor driver 500 may be coupled between the main processor 300 and the co-processor 400. The co-processor driver 500 may enable the main processor 300 and the co-processor 400 to communicate with each other.

When the co-processor driver 500 receives the core code call from the main processor 300, the co-processor driver 500 may transfer the core code call to the co-processor 400. In addition, when the co-processor driver 500 receives the core code execution result from the co-processor 400, the co-processor driver 500 may transfer the core code execution result to the main processor 300.

The core code storage 600 may be accessed only by the co-processor 400. The core code storage 600 may store the core code 103. The co-processor 400 may store the core code 103, which is separated from the mobile application program 100 when the mobile application program 100 is installed on the mobile device, in the core code storage 600.

The normal code storage 700 may store the normal code 101 of the mobile application program 100.

The DRAM 800 may include the encrypted shared memory 900. The encrypted shared memory 900 may store the execution code of the main processor 300 and the execution code of the co-processor 400 in an encrypted form. The main processor 300 and the co-processor 400 may share the encrypted execution code with each other using the encrypted shared memory 900.

Hereinafter, an example of an operation of the mobile device will be described based on the structure of the mobile device described above.

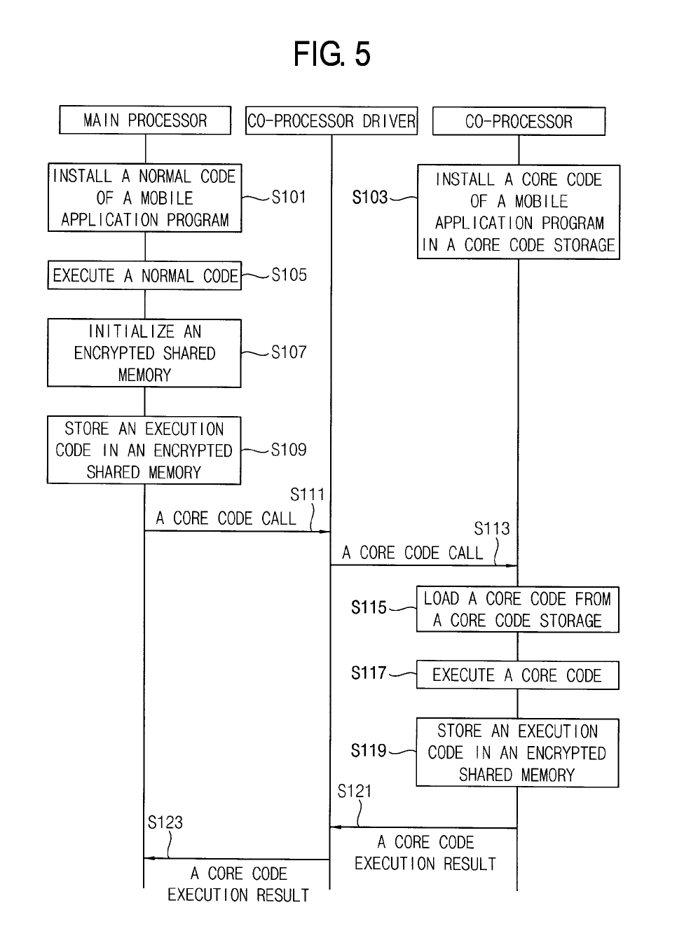

FIG. 5 is a flow chart illustrating an operation of a mobile device according to example embodiments.

Referring to FIG. 5, the main processor 300 may install the normal code 101 of the mobile application program 100 (S101).

The co-processor 400 may install the core code 103 of the mobile application program 100 in the core code storage 600 (S103).

As described above, when the mobile device installs the mobile application program 100 using the co-processor 400, the normal code 101 and the core code 103 may be installed separately. The core code 103 may be stored in the core code storage 600, to which the main processor 300 and the normal code 101 of the mobile application program 100 are not allowed to access, and be executed by the co-processor 400.

After that, when the main processor 300 calls the core code 103 while executing the normal code 101 (S105), the main processor 300 may initialize the encrypted shared memory 900 (S107). In addition, the main processor 300 may, if required, store an execution code, which is executed by the main processor 300, in the encrypted shared memory 900 in an encrypted form (S109). That is, when the main processor 300 calls the core code 103 while executing the normal code 101, the main processor 300 may, if required, initialize the encrypted shared memory 900 and store the execution code in the encrypted shared memory 900 in an encrypted form.

The main processor 300 may transfer the core code call to the co-processor driver 500 (S111), and the co-processor driver 500 may transfer the core code call to the co-processor 400 (S113). Therefore, the main processor 300 may communicate with the co-processor 400 by transferring the core code call to the co-processor driver 500.

The co-processor 400 may load the core code 103 from the core code storage 600 (S115) and execute the core code 103 (S117).

The co-processor 400 may store an execution code, which is executed by the co-processor 400, in the encrypted shared memory 900 in an encrypted form (S119).

After the co-processor 400 executes the core code 103, the co-processor 400 may transfer the core code execution result to the co-processor driver 500 (S121).

The co-processor driver 500 may transfer the core code execution result to the main processor 300 (S123). Therefore, the co-processor 400 may communicate with the main processor 300 by transferring the core code execution result to the co-processor driver 500.

As described above, the normal code 101 may be executed only by the main processor 300 and the core code 103 may be executed only by the co-processor 400, such that the core code 103 may not be exposed to the main processor 300 when the mobile application program 100 is executed. In addition, data stored in the encrypted shared memory 900, which is shared by the main processor 300 and the co-processor 400, may be encrypted. Therefore, the mobile application program 100 may have an increased resistance to a reverse engineering attack.

Although the present inventive concept is described above to be implemented with the mobile device and the method of operating the mobile device, example embodiments are not limited thereto. According to example embodiments, the present inventive concept may be implemented with a computer program performing the operations described above or a computer readable medium storing the computer program.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

### REFERENCE NUMERALS

100: mobile application program
101: normal code
103: core code
200: system-on-chip
300: main processor
301: normal code execution circuit
303: core code calling circuit
305: shared memory encryption decryption circuit
400: co-processor
401: core code execution circuit
403: core code response circuit
405: shared memory encryption decryption circuit
500: co-processor driver
600: core code storage
700: normal code storage
800: dynamic random access memory
900: encrypted shared memory

What is claimed is:

1. A mobile device, comprising:
a main processor configured to execute a normal code of a mobile application program, the normal code including commands executable by the main processor;
a co-processor configured to execute a core code of the mobile application program, the core code including commands executable by the co-processor; and
a co-processor driver coupled between the main processor and the co-processor, the co-processor driver enabling the main processor and the co-processor to communicate with each other.

2. The mobile device of claim 1, further comprising:
a core code storage configured to be accessed only by the co-processor, the core code storage storing the core code, and
wherein the co-processor stores the core code, which is separated from the mobile application program when the mobile application program is installed on the mobile device, in the core code storage.

3. The mobile device of claim 2, wherein when the co-processor driver receives a core code call from the main processor, the co-processor driver transfers the core code call to the co-processor, and
wherein when the co-processor driver receives a core code execution result from the co-processor, the co-processor driver transfers the core code execution result to the main processor.

4. The mobile device of claim 3, wherein when the co-processor receives the core code call from the co-processor driver, the co-processor loads the core code from the core code storage and executes the core code.

5. The mobile device of claim 4, further comprising:
an encrypted shared memory configured to being used for sharing encrypted data, and
wherein when the main processor calls the core code while executing the normal code, the main processor stores data of the normal code in the encrypted shared memory in an encrypted form, and
wherein the co-processor decrypts the encrypted data stored in the encrypted shared memory to refer the decrypted data.

6. The mobile device of claim 5, wherein while the co-processor executes the core code, the co-processor stores data of the core code in the encrypted shared memory in an encrypted form, and
wherein the main processor decrypts the encrypted data stored in the encrypted shared memory to refer the decrypted data.

7. The mobile device of claim 1, wherein the core code is determined by a user or a function predetermined based on a mobile platform.

8. A method of operating a mobile device including a main processor, a co-processor, and a co-processor driver enabling the main processor and the co-processor to communicate with each other, comprising:
calling, by the main processor, a core code of a mobile application program, the core code including commands executable by the co-processor;
transferring, by the co-processor driver, the core code call received from the main processor to the co-processor;
transferring, by the co-processor, a core code execution result to the co-processor driver after executing the core code; and
transferring, by the co-processor driver, the core code execution result to the main processor.

9. The method of claim 8, further comprising:
storing, by the co-processor, the core code, which is separated from the mobile application program when the mobile application program is installed on the mobile device, in a core code storage before the main processor calls the core code, and
wherein the transferring, by the co-processor, the core code execution result to the co-processor driver after executing the core code includes:
loading the core code from the core code storage to execute the core code; and
transferring the core code execution result to the co-processor driver.

10. The method of claim 9, wherein the calling, by the main processor, the core code of the mobile application program includes:
executing, by the main processor, a normal code of the mobile application program, the normal code including commands executable by the main processor; and
transferring, by the main processor, the core code call to the co-processor driver when the main processor determines that the core code is required to be called.

11. The method of claim 10, further comprising:
storing, by the main processor, data of the normal code in an encrypted shared memory in an encrypted form when the main processor calls the core code while executing the normal code;
storing, by the co-processor, data of the core code in the encrypted shared memory in an encrypted form while the co-processor executes the core code; and
sharing, by the main processor and the co-processor, the encrypted data using the encrypted shared memory.
